(19) United States
(12) Patent Application Publication
(10) Pub. No.: US 2006/0027610 A1
(43) Pub. Date: Feb. 9, 2006

(54) Dispenser

(76) Inventor: John Bowyer, Swindon (GB)

Correspondence Address: BARLEY SNYDER, LLC, 1000 WESTLAKES DRIVE, SUITE 275, BERWYN, PA, 19312, US

(21) Appl. No.: 11/148,078

(22) Filed: Jun. 8, 2005

(30) Foreign Application Priority Data
Jun. 8, 2004 (EP) 04253401.6

(51) Int. Cl. B67D 3/00

(52) U.S. Cl. 222/527

(57) ABSTRACT

A dispenser and a method for measuring and dispensing a small quantity of fluid comprises a dosing apparatus and an apertured member. The dosing apparatus has a nozzle for dispensing the fluid. The apertured member is mounted on a moveable plate assembly. The apertured member has an active portion. The active portion is moveable into engagement with the nozzle to remove the fluid from the nozzle.

### FIELD OF THE INVENTION

The invention relates to a dispenser suitable for dispensing very small measured quantities of fluid and a method of performing the same.

### BACKGROUND OF THE INVENTION

When a measured quantity of a droplet or sub-droplet of a fluid, such as liquid, paste, or grease, is to be dispensed, a number of problems can occur. For example, it is difficult to repeatedly dispense the same volume of the fluid consistently. Additionally, it is difficult to separate the fluid from a nozzle through which the fluid has been dispensed without leaving more than a trace of the fluid on the nozzle, and stringing may occur leaving a trail of fluid connected to the nozzle. Finally, air and also possibly some of the fluid dispensed from the nozzle may be drawn back into a device used to measure out the fluid. These problems occur, because the surface tension and the viscosity of the fluid are exacerbated when very small volumes, such as 1 microliter, are being dispensed.

For example, one application in which it is necessary to dispense a very small volume of fluid, such as, a medicament, perfume, insecticide, fungicide, vegetable extract, or plant abstract is when a small volume of fluid is measured out and subsequently heated to vaporize the fluid. Because of the problems previously discussed, however, dispensing a desired volume of the fluid onto a suitable heating member is difficult.

It is therefore an object of the invention to provide a dispenser and method of dispensing a very small volume of fluid which overcomes at least some of these problems. It is further an object of the invention to provide a dispenser which is suitable for dosing out a very small volume of fluid for vaporization.

### SUMMARY OF THE INVENTION

This and other objects are achieved by a dispenser for measuring and dispensing a small quantity of fluid. The dispenser comprises a dosing apparatus and an apertured member. The dosing apparatus has a nozzle for dispensing the fluid. The apertured member is mounted on a moveable plate assembly. The apertured member has an active portion. The active portion is moveable into engagement with the nozzle to remove the fluid from the nozzle.

This and other objects are further achieved by a dispenser for measuring and dispensing a small quantity of fluid, comprising a dosing apparatus. The dosing apparatus includes an outer shell with a fluid inlet and a fluid outlet. A core is mounted in the outer shell. The core has a core opening with a measuring chamber displaceable between the fluid inlet and the fluid outlet. A piston is arranged in the core opening and is displaceable therein.

This and other objects are still further achieved by a method of dispensing a small quantity of fluid. The method comprises the steps of forcing a measured quantity of fluid through a nozzle, positioning an active portion of an apertured member in contact with the fluid to remove the fluid from the nozzle, and displacing the apertured member away from the nozzle.

### BRIEF DESCRIPTION OF THE DRAWINGS

FIG. 1 is a perspective partial sectional view of a dispenser according to the invention;

FIG. 2 is a side view of the dispenser taken from a direction of arrow B in FIG. 1;

FIG. 3 is a top view of the dispenser taken from a direction of arrow C with region A-A in FIG. 3 shown in cross-section;

FIG. 4 is a top view of the dispenser with a moving plate assembly removed;

FIG. 5 is a side view of a piston of the dispenser;

FIG. 6 is a side view of an electrode of the dispenser;

FIG. 7 is a side view of a core member of the dispenser;

FIG. 8 is a sectional view of the core member taken along line D-D of FIG. 7;

FIG. 9 is a side view of an outer shell of the dispenser;

FIGS. 10 through 14 are top views of the dispenser showing the dispenser in varies operating states; and

FIG. 15 is a schematic view of a control system for controlling the dispenser.

### DETAILED DESCRIPTION OF THE INVENTION

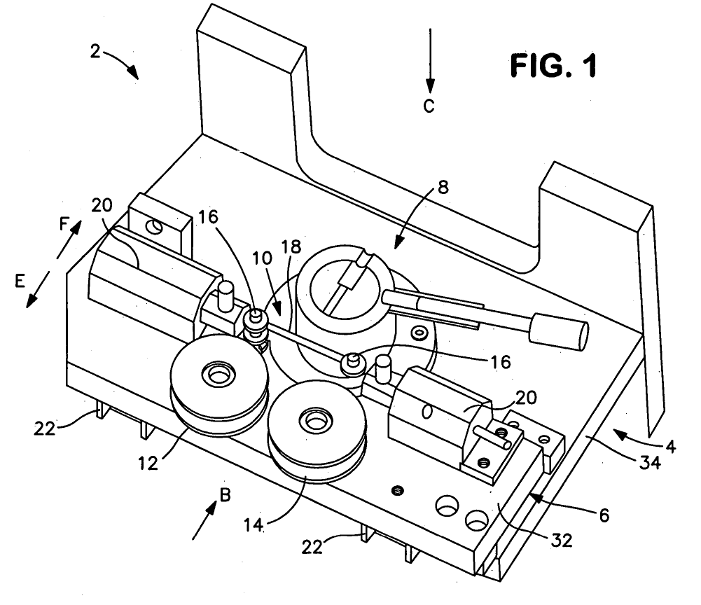

FIG. 1 shows a dispenser 2 according to the invention. The dispenser 2 includes a fixed base assembly 4 and a moving plate assembly 6. The base assembly 4 includes a fluid delivery member or dosing apparatus 8. The moving plate assembly 6 is slidable back and forth relative to the base assembly 4 in a direction indicated by arrows E and F. The moving plate assembly 6 includes an apertured member 10 that is windable past the dosing apparatus 8 from a supply reel 12 onto a take-up reel 14 around rollers 16 between which an active portion 18 of the apertured member 10 extends. An electrode assembly 20 extends outwardly from each of the rollers 16.

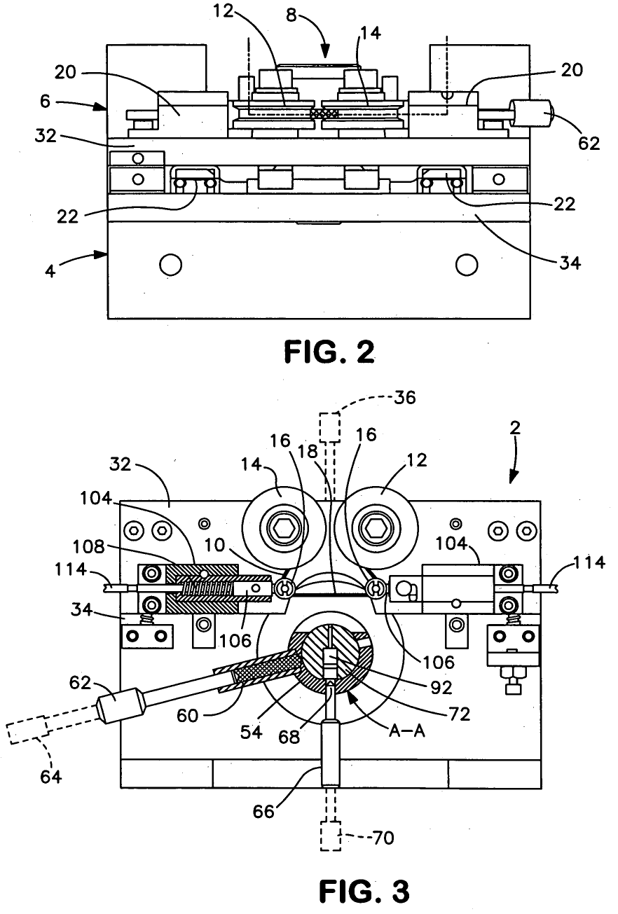

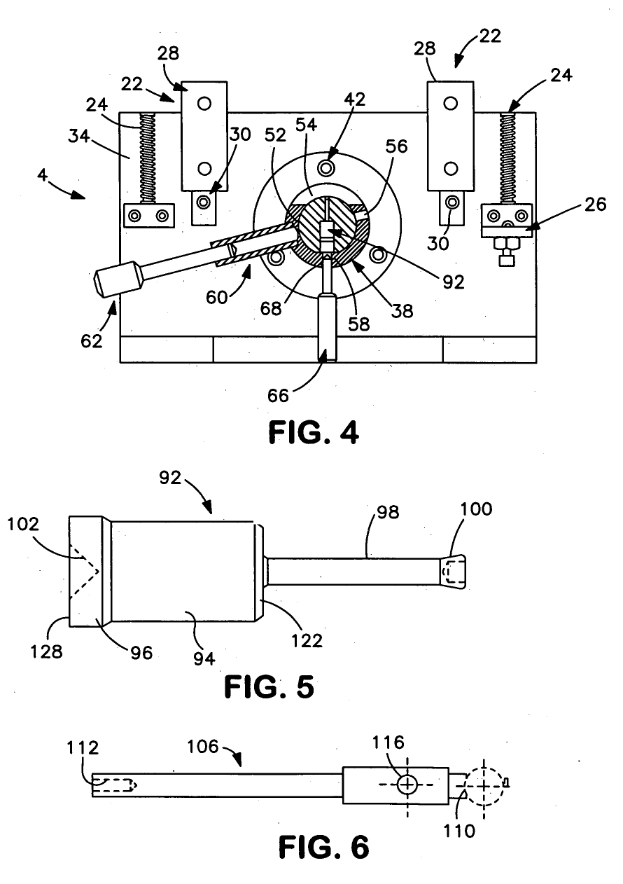

The moving plate assembly 6 is mounted on the base assembly 4 by two ball slides 22, as shown in FIG. 2. As best shown in FIG. 4 where the moving plate assembly 6 has been omitted, each of the ball slides 22 includes a first portion 28, which is connected to a moving plate 32 of the moving plate assembly 6, and a second portion 30, which is connected to a base plate 34 of the base assembly 4. Springs 24 are mounted on the base plate 34 by spring mounts 26. The springs 24 bias the moving plate assembly 6 in the direction of the arrow E. As shown in FIG. 3, a plate actuator 36 is provided for displacing the moving plate assembly 6 in the direction of the arrow F.

FIGS. 3 through 9 show the dosing apparatus 8. As shown in FIG. 9, the dosing apparatus 8 includes an outer shell 38. The outer shell 38 has a flange 40 at a lower end thereof, an upstanding cylindrical member 44, and a bore 46. As shown in FIG. 4, the flange 40 is secured to the base plate 34 by bolts 42. As shown in FIG. 9, the cylindrical member 44 has a fluid inlet 52, a fluid outlet 54, a vent 56, and an actuator passage 58 that are aligned on a plane 48 extending perpendicular to a central longitudinal axis 50 of the outer shell 38. The actuator passage 58 is positioned diametrically opposite to the fluid outlet 54. The vent 56 is positioned diametrically opposite the fluid inlet 52, as shown in FIG. 4. As shown in FIG. 9, a pin track 82 extends part of the way around a perimeter of an upper end 78 of the outer shell 38. As shown in FIG. 3, a tubular reservoir 60 is connected to the fluid inlet 52. A plunger 62 slidably engages an inner surface of the tubular reservoir 60. A plunger actuator 64 is arranged to urge the plunger 62 into the tubular reservoir 60. The tubular reservoir 60, the plunger 62, and the plunger actuator 64 may also be in the form of a syringe which can be supplied in a sealed form containing, for example, a medicament.

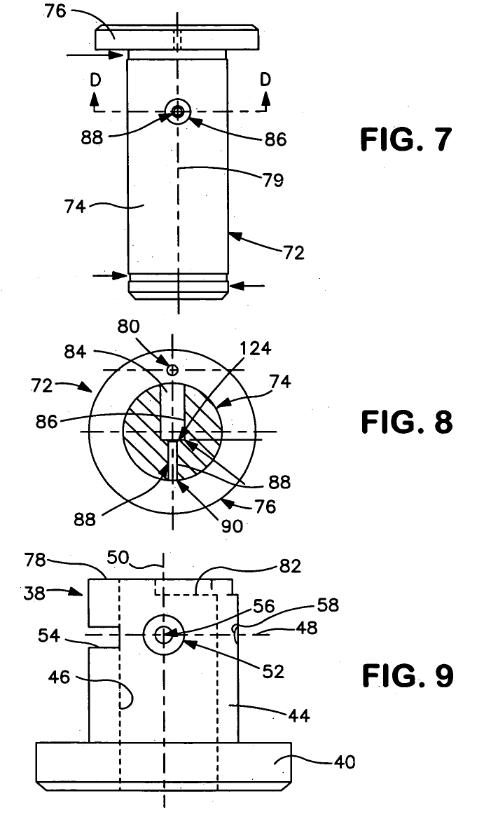

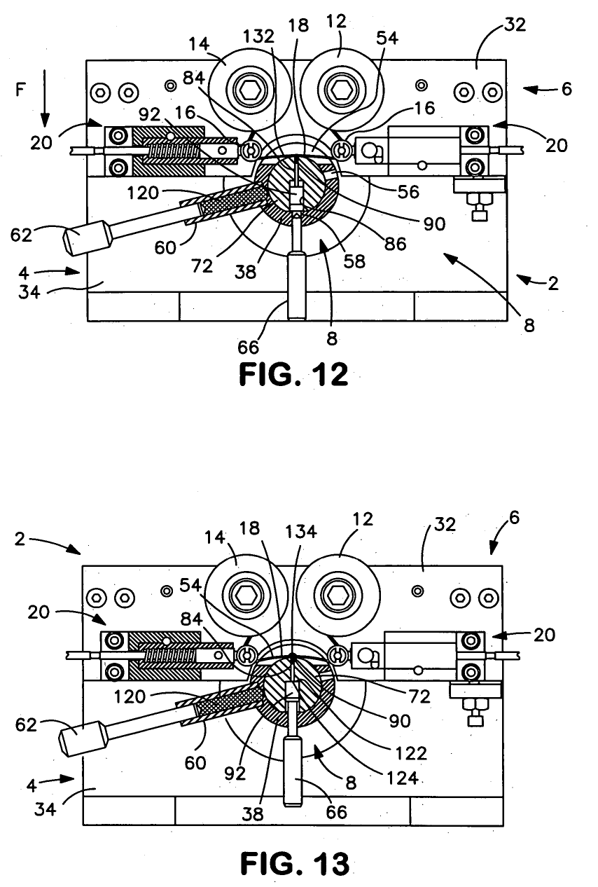

FIG. 7 shows a core 72 with an outer surface 74 and a central longitudinal axis 79 about which it rotates. The core 72 snugly fits in the bore 46 and includes a head 76. The head 76 slidingly engages the upper end 78 of the outer shell 38 when the core 72 is slidingly fit in the bore 46. As shown in FIG. 8, the bore 46 has a bore shoulder 124, and a pin 80 extends through the head 76 of the core 72 and into engagement with the pin track 82. The movement of the pin 80 in the pin track 82 limits rotation of the core 72 in the outer shell 38 so that it can only move between the positions shown, for example, in FIGS. 11 and 12. With the core 72 so engaged with the outer shell 38, a core opening 84 in the core 72 is axially aligned with the fluid inlet 52, etc. The core opening 84 includes a relatively larger diameter portion 86, a relatively smaller diameter portion 88, and an outlet nozzle 90 at a distal end of the smaller diameter portion 88.

A piston 92, as shown in FIG. 5, is slidingly positioned in the core opening 84. The piston 92 includes a larger diameter portion 94 with a skirt 96 at a distal end thereof that is positioned in the larger diameter portion 86 of the core opening 84, and a smaller diameter portion 98 with an outwardly flared head 100 that is positioned in the smaller diameter portion 88 of the core opening 84. The outwardly flared head 100 sealingly engages with an inner surface of the smaller diameter portion 88 of the core opening 84 to minimize the chance of fluid 120 or air by-passing the piston 92. A recess 102 is provided on an end surface 128 of the larger diameter portion 94 of the piston 92 for receiving an inner end 68 of a piston drive member 66, which is located in the actuator passage 58. The piston 92 includes a shoulder 122 that engages the bore shoulder 124. A piston actuator 70 is arranged to urge the piston drive member 66 through the actuator passage 58 and into the interior of the outer shell 38 and return it to the position shown in FIG. 3.

As shown in FIG. 3, each of the electrode assemblies 20 is a mirror image of the other and includes an electrode housing 104 and an electrode 106. The electrode 106 is slidably positioned in the electrode housing 104 and includes a tip 110 and a connection end 112, as shown in FIG. 6. The tip 110 projects toward an adjacent roller 16, and the connection end 112 projects from an opposite end of the housing 104 and is connected to an electrical supply lead 114, as shown in FIG. 3. As shown in FIG. 6, an electrode spring 108 in the electrode housing 104 biases the tip 110 towards the adjacent roller 16. The tip 110 has a radius R that matches a radius of the adjacent roller 16. A locking peg 116 projects from the electrode 106 and is movable along an L-shaped peg track in the electrode housing 104 so as to lock the electrode 106 with the tip 110 held away from the roller 16. It may be necessary to lock the electrode 106 with the tip 110 held away from the roller 16, for example, when the supply reel 12 and the take-up reel 14 are being replaced.

The apertured member 10 may be made of, for example, a strip of metal mesh, a foil member containing apertures made by a process such as laser piercing, an absorbent paper member, or an absorbent glass mat. If the apertured member 10 is made of steel, for example, the apertured member 10 may be composed of wires having 28 μm diameters and apertures having 36 μm diameters. For the purpose of dispensing the a fluid 120 with a slightly oily consistency, such as the vegetable or plant extract mentioned above, the apertured member 10 may comprise filaments having diameters in a range of 25 μm to 35 μm and apertures having diameters in a range of 30 μm to 40 μm. Depending on the different viscosities and surface tensions of the fluid 120, however, the apertured member 10 may be formed with different characteristics. As shown in FIG. 3, the apertured member 10 is wound around the supply reel 12. The active portion 18 of the apertured member 10 extends from the supply reel 12 around the rollers 16 so that the electrodes 106 nip the apertured member 10 against the rollers 16 for supplying an electrical potential across the active portion 18 of the apertured member 10. The apertured member 10 is then wound onto the take-up reel 14.

The moving plate assembly 6 and the fixed plate assembly 4 may be made of aluminium. The outer shell 38, the core 72, the piston 92, the plunger 62 and the tubular reservoir 60 may be made of a polyester (PET). The plate, plunger, and piston actuators 36, 64, 70 may be made of stainless steel. The supply reel 12, the take-up reel 14 and the rollers 16 may be made of a plastic material, such as TUFSET. The electrodes 16 may be made of phosphor bronze. To reduce costs in a production version, however, as many components as possible may be molded from plastic materials and additionally some combinations of the separate components described herein may be formed as integral moldings.

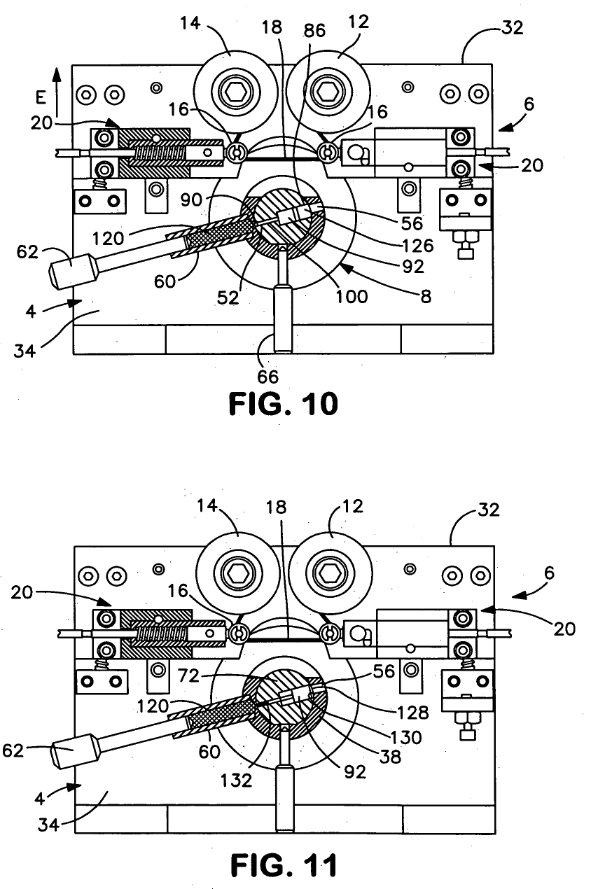

The operation of the dispenser 2 will now be described with reference to FIGS. 10 through 14. As shown in FIG. 10, at the beginning of a dispensing cycle, the tubular reservoir 60 is provided with a supply of the fluid 120, which is to be measured out. The moving plate assembly 6 is displaced in the direction of the arrow E so that the active portion 18 is spaced from the fluid outlet 54 (FIG. 4). A non-used portion of the active portion 18 of the apertured member 10 is extended between the rollers 16. The core 72 is positioned such that the nozzle 90 lines up with the fluid inlet 52 of the outer shell 38. The piston 92 is positioned with the shoulder 122 against the bore shoulder 124. In this position, the head 100 of the piston 92 is situated at the nozzle 90 and a space 126 at an opposite end of the piston 92 in the larger diameter portion 86 of the core opening 84 is aligned with the vent 56.

As shown in FIG. 11, the plunger actuator 64 (FIG. 3) then depresses the plunger 62 to force the fluid 120 from the tubular reservoir 60 through the fluid inlet 52 (FIG. 4) and the nozzle 90 into the smaller diameter portion 88 of the core opening 84. The piston 92 is thereby displaced until the end surface 128 of the piston 92 abuts an inner surface 130 of the outer shell 38, which constitutes a piston stop. As the piston 92 moves to this position, air contained in the space 126 is exhausted through the vent 56. At this point, the portion of the smaller diameter portion 88 of the core opening 84 occupied by the fluid 120 constitutes a measuring chamber 132 and is filled with a measured volume of the fluid 120 which will be dispensed by the dispenser 2.

As shown in FIG. 12, the core 72 is then rotated clockwise until the larger diameter portion 86 of the core opening 84 becomes aligned with the actuator passage 58 at which point the nozzle 90 becomes aligned with a central portion of the fluid outlet 54. At the same time, or immediately before or after such rotation, the moving plate assembly 6 is displaced in the direction of the arrow F by the plate actuator 36 so that the active portion 18 of the apertured member 10 is pressed against the nozzle 90.

As shown in FIG. 13, the piston actuator 70 (FIG. 3) is then extended to drive the piston drive member 66 through the actuator passage 58, so that the inner end 68 engages the recess 102 in the end surface 128 of the piston 92. Continued movement of the piston drive member 66 forces the piston 92 into the core opening 84 until the piston shoulder 122 contacts the core shoulder 124 to force the fluid 120 out of the measuring chamber 132, through the nozzle 90, and through the active portion 18 where a bead 134 of the fluid 120 is formed.

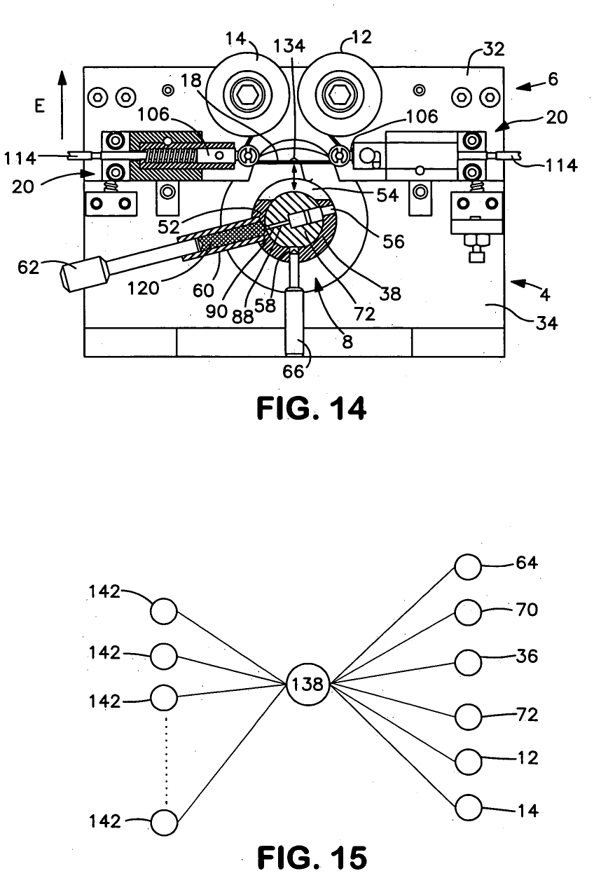

As shown in FIG. 14, the moving plate assembly 32 is then displaced away from the dosing apparatus 8 in the direction of the arrow E by action of the plate actuator 36 and the springs 24. A gap L is thereby formed between the active portion 18 and the core 72. Surface tension forces acting between the active portion 18 and the bead 134 of the fluid 120 cause substantially all of the fluid 120 to remain on or in the apertured member 10. Only a slight trace of the fluid 120 is therefore left on the nozzle 90 of the core 72, and the fluid 120 that has been dispensed is prevented from being drawn back into the dosing apparatus 8. A voltage is then applied between the electrodes 106 via the leads 114. A current flows through the active portion 18, which causes the active portion 18 to heat up and thereby vaporize the bead 134. When the dispenser 2 is being used to vaporize a medicament, it will preferably be constructed in miniaturized form and incorporated within an inhaler device.

Before the next cycle commences, the active portion 18 will be wound onto the take-up reel 14, which will draw an unused portion of the active portion 18 into the region between the rollers 16. The core 72 is rotated counter-clockwise to the position shown in FIG. 14 where the smaller diameter portion 88 of the core opening 84 is once again lined up with the fluid inlet 52. The dispenser 2 is thereby ready for the next cycle.

So as to reduce the amount of operator intervention which is required to operate the dispenser 2, it preferably includes a controller 138 that carries out the above cycle, as shown in FIG. 15. Inputs to the controller 138 will be provided from position sensors 142, which sense the positions of components, such as the plunger 62, the piston 92, the core 72, the supply reel 12, and the take-up reel 14. Outputs from the controller 138 will be used to control components, such as the plunger actuator 64 for displacing the plunger 62, the piston actuator 70 for displacing the piston 92, the plate actuator 36 for displacing the moving plate assembly 6, the core 72, the supply reel 12, and the take-up reel 14 and for controlling the supply of electrical current.

The dispenser 2 according to the invention prevents contamination of a supply of the fluid 120 connected to the fluid inlet 52, and the piston 92 can be used to repeatedly measure out precisely the same volume of the fluid 120 while minimizing the chance of air becoming entrained in the fluid 120. Because, the core opening 84 has a smaller diameter portion 88 defining the measuring chamber 132 and a relatively larger diameter portion 86 that respectively accommodates relatively larger and smaller diameter portions 94, 98 of the piston 92, the volume of the measuring chamber 132 can be very small while the area of the piston 92 available for piston displacement can be any convenient size. Additionally, the core 72 is rotatable about a central longitudinal axis 79 relative to the outer shell 38 so as to make the dispenser 2 compact. The core 72 may alternatively be longitudinally displaceable.

I/We claim:

1. A dispenser for measuring and dispensing a small quantity of fluid, comprising:
a dosing apparatus having a nozzle for dispensing the fluid; and
an apertured member mounted on a moveable plate assembly, the apertured member having an active portion moveable adjacent to the nozzle to remove the fluid from the nozzle.

2. The dispenser of claim 1, wherein the apertured member is a metal mesh.

3. The dispenser of claim 2, wherein the apertured member includes filaments having diameters in a range of 25 μm to 35 μm

4. The dispenser of claim 2, wherein the apertured member includes apertures having diameters in a range of 30 μm to 40 μm.

5. The dispenser of claim 1, wherein the apertured member is advanceable from a supply reel to a take-up reel, the active portion of the apertured member being positioned there between.

6. The dispenser of claim 1, wherein the apertured member is supported by rollers, the active portion of the apertured member being positioned there between.

7. The dispenser of claim 6, wherein each of the rollers has an electrode moveable into engagement therewith, the electrodes supplying an electrical potential across the active portion when engaged with the apertured member and the rollers.

8. The dispenser of claim 1, further comprising a controller.

9. The dispenser of claim 1, wherein the dosing apparatus includes an outer shell with a fluid inlet and a fluid outlet, a core is mounted in the outer shell, the core having a core opening with a measuring chamber displaceable between the fluid inlet and the fluid outlet, and a piston arranged in the core opening and displaceable therein.

10. The dispenser of claim 9, wherein the measuring chamber is rotatable about a central longitudinal axis of the outer shell.

11. The dispenser of claim 9, wherein the core opening has a smaller diameter portion and a larger diameter portion, the smaller diameter portion defining the measuring chamber, and the piston has smaller and larger diameter portions corresponding thereto.

12. The dispenser of claim 11, wherein the smaller diameter portion is outwardly flared and sealingly engages an inner surface of the measuring chamber.

13. The dispenser of claim 11, wherein the nozzle communicates with the smaller diameter portion of the core opening.

14. The dispenser of claim 9, wherein the outer shell has a vent positioned opposite to the fluid inlet.

15. The dispenser of claim 9, wherein the outer shell has an actuator passage positioned opposite to the fluid outlet, a piston drive member extends through the actuator passage and engages the piston to drive the piston through the core opening.

16. The dispenser of claim 9, further comprising a tubular reservoir connected to the fluid inlet for supplying the fluid into the measuring chamber.

17. The dispenser of claim 1, wherein the active portion is moveable into engagement with the nozzle.

18. A dispenser for measuring and dispensing a small quantity of fluid, comprising:
a dosing apparatus including an outer shell with a fluid inlet and a fluid outlet;
a core mounted in the outer shell, the core having a core opening with a measuring chamber displaceable between the fluid inlet and the fluid outlet; and
a piston arranged in the core opening and displaceable therein.

19. The dispenser of claim 18, wherein the measuring chamber is rotatable about a central longitudinal axis of the outer shell.

20. The dispenser of claim 18, wherein the core opening has a smaller diameter portion and a larger diameter portion, the smaller diameter portion defining the measuring chamber, and the piston has smaller and larger diameter portions corresponding thereto.

21. The dispenser of claim 20, wherein the smaller diameter portion is outwardly flared and sealingly engages an inner surface of the measuring chamber.

22. The dispenser of claim 20, wherein a nozzle communicates with the smaller diameter portion of the core opening.

23. The dispenser of claim 18, wherein the outer shell has a vent positioned opposite to the fluid inlet.

24. The dispenser of claim 18, wherein the outer shell has an actuator passage positioned opposite to the fluid outlet, a piston drive member extends through the actuator passage and engages the piston to drive the piston through the core opening.

25. The dispenser of claim 18, further comprising a tubular reservoir connected to the fluid inlet for supplying the fluid into the measuring chamber.

26. A method of dispensing a small quantity of fluid, comprising the steps of:
forcing a measured quantity of fluid through a nozzle;
positioning an active portion of an apertured member in contact with the fluid to remove the fluid from the nozzle; and
displacing the apertured member away from the nozzle.

27. The method of claim 26, further comprising supplying an electrical potential across the active portion after the apertured member is displaced.

28. The method of claim 26, further comprising retaining the fluid on the active portion by surface tension.

29. The method of claim 26, further comprising engaging the active portion with the nozzle.
